(19) United States
(12) Patent Application Publication
(10) Pub. No.: US 2026/0308410 A1
(43) Pub. Date: Oct. 8, 2026

(54) A BIOBASED RADICAL CURABLE COMPOSITION FOR COATINGS

(71) Applicant: ALLNEX BELGIUM, S.A., Drogenbos (BE)

(72) Inventor: Patrice ROOSE, Sint Pieters Leeuw (BE)

(73) Assignee: ALLNEX BELGIUM, S.A., Drogenbos (BE)

(21) Appl. No.: 19/480,927

(22) PCT Filed: May 2, 2024
(86) PCT No.: PCT/EP2024/062064

§ 371 Date: Nov. 3, 2025

(30) Foreign Application Priority Data
May 5, 2023 (EP) 23171909.7

(51) Int. Cl. C09D 151/08; C08F 283/06; C09D 4/00; C09D 15/00

(52) U.S. Cl. CPC C09D 151/08; C08F 283/065; C09D 4/00; C09D 15/00

(57) ABSTRACT

A radical curable coating composition comprising: •from 10 wt % to 70 wt % of one or more compounds A, each compound A comprising a poly(trimethylene ether) moiety and one or two (meth)acrylate groups; wherein the poly(trimethylene ether) moiety is incorporated into compound A by a condensation reaction of a poly(trimethylene ether) glycol with an (meth)acrylate compound selected from the group consisting of (meth)acrylic acid, (meth)acryloyl chloride, and alkylesters thereof, the poly(trimethylene ether) glycol having a number average molecular weight Mn, measured by GPC with polystyrene as the standard, of from 900 to 5000 Dalton, •from 30 wt % to 90 wt % of one or more (meth)acrylate compounds B, wherein each compound B comprises two or more (meth)acrylate groups, wherein the one or more (meth)acrylate compounds B, combined, have a viscosity of at most 10000 mPa·s at 25° C.; and•from 0 wt % to 25 wt % of one or more other compounds C.

### FIELD OF THE INVENTION

The present invention relates to a free-radical curable coating composition, and more in particular to biobased compositions for forming a coating on various substrates, for instance, on wood.

### BACKGROUND OF THE INVENTION

Non-biobased acrylate technology typically involves viscous precursors (so-called “oligomers”) which offer wide-ranging options for the control of the cured coating properties. Reactive diluents are added to improve the flow properties of the precursor.

However, adding too much of a reactive diluent often results in a highly brittle cured coating.

Wood flooring can give a living room a natural beauty and warm ambiance. However, it is a demanding application and requires very good wear resistance.

Radiation curable compositions are excellent for finishing parquet and laminate because they are very scratch and wear resistant. Furthermore, Ultraviolet (UV) and Electron Beam (EB) curing allow for a very cost-effective and lean production process. In fact, panels can be roller-coated with solvent free 100% solids systems, followed by an immediate on-line UV/EB curing step.

A good abrasion resistance, and in particular a good resistance against the wearing effect of fine hard particles like sand, is highly desirable for parquet and laminate floorings. Special urethane(meth)acrylates have been developed for this kind of abrasion resistance and are commercially available. However, urethane acrylate resins are typically viscous and require suitable thinning of their flow properties using reactive diluents. As reactive diluents increase the brittleness of the coatings after curing, the trade-off between liquid and solid coating properties is not straightforward to achieve. Resins with a similar effect as urethane-acrylates but with significantly lower viscosities are still unavailable.

Typically, UV-curing lines for the production of wood coatings run at speeds of about 25 to 30 m min⁻¹ and require compositions with a high reactivity which also remain challenging when scratch and abrasion resistance is targeted.

Coating of wood substrates for protective an aesthetic purposes is laborious compared to other substrates such as plastic, metal and glass which are well-defined materials and essentially flat. In particular, prior to the application of the top coating, the wood surface is treated and sanded repetitively until a well-defined “sealed” layer is achieved. The coating resin in this step should meet specific requirements including a suitable viscosity level for roll application; a high reactivity (i.e. drying) upon curing; and after curing: excellent sandability (setting a limit on material softness), stain resistance (eosin, mustard, coffee), no whitening upon contact with water, solvent resistance, and finally resistance to potential damage and wear from e.g. scratching and abrasion of the overall coating system.

Furthermore, there is a growing demand in the market for biofriendly alternatives that result in performing coatings in terms of curing reactivity, adhesion, scratch and abrasion resistance, with equal or even better performances than the state-of-the-art coatings systems. An example of state-of-the-art systems is described in WO2011/131501, which provides a radiation-curable amino (meth)acrylate obtained from the reaction of an amine with a mixture comprising an urethane(meth)acrylate and a (meth)acrylated diluent. Furthermore, WO2023/282117 describes an adhesive composition comprising a compound that is the reaction product of a reaction between di(meth)acrylate and polytrimethylene glycol, wherein the composition further comprises an urethane(meth)acrylate, and a hydroxypropyl methacrylate.

There is therefore a need in the art for improved polymeric materials suitable for wood coating and that overcome, at least partially, one or more of the above issues.

### SUMMARY

It is hence an object of the present invention to develop a free-radical curable composition for coatings that can be biobased.

The free-radical curable compositions of the present invention may have one or more of the following advantages:

They may have a reactivity fitting with typical wood coating line speeds of about 25 to 30 m·min⁻¹ and which results in very well performing coatings in terms of curing reactivity.

They may have good adhesion.

They may have good scratch and abrasion resistance after curing.

They may have good hardness after curing.

They may have a low viscosity. The unique viscosity levels of embodiments of the present invention make them suitable for a variety of liquid coating applications, such as spray or jetting techniques. By substituting a non-biobased, viscous precursor in the formulation with a high molar mass, typically biobased component (component A) of low viscosity, these embodiments enable toughness and flexibility enhancements while still maintaining a low viscosity for the liquid coating composition.

They may have tunable mechanical properties for various applications after curing. In particular, the coating properties can be tailored in order to achieve a right balance between toughness/flexibility and stiffness at a high biobased content keeping the viscosity level of the composition low before curing.

They may comprise a low amount of volatile organic compounds and, hence, may have a low toxicity and flammability.

They may be applied by cost-effective and lean production processes.

They may be applicable to various substrates, for instance, on wood.

To this end, in a first aspect, the present invention relates to a radical curable coating composition comprising the following compounds:
from 10 wt % to 70 wt %, based on the total weight of the coating composition, of one or more compounds A, each compound A comprising a poly(trimethylene ether) moiety and one or two (meth)acrylate groups; wherein the poly(trimethylene ether) moiety is incorporated into compound A by a condensation reaction of a poly(trimethylene ether) glycol with an (meth)acrylate compound selected from the group consisting of (meth)acrylic acid, (meth)acryloyl chloride, and alkylesters thereof, the poly(trimethylene ether) glycol having a number average molecular weight Mn, measured by GPC with polystyrene as the standard, of from 900 to 5000 Dalton,
from 30 wt % to 90 wt %, based on the total weight of the coating composition, of one or more (meth)acrylate compounds B different from the one or more compounds A, and wherein each compound B comprises two or more (meth)acrylate groups, wherein the one or more (meth)acrylate compounds B, combined, have a viscosity of at most 10000 mPa·s at 25° C.; and have weight average molecular weight of at most 4000 Dalton, preferably at most 1000 Dalton, and
from 0 wt % to 25 wt %, based on the total weight of the coating composition, of one or more other compounds C, different from compounds A and B.

The present invention also relates, in a second aspect, to the use of a radical curable coating composition according to any embodiment of the first aspect as one or more layers of a substrate coating.

In a third aspect, the present invention relates to a method of forming a coating comprising applying a layer of the radical curable coating composition according to an embodiment of the first aspect, to at least a portion of a substrate and submitting the coated substrate to curing conditions.

In a fourth aspect, the present invention relates to a substrate in contact with the radical curable coating composition according to any embodiment of the first aspect.

### DETAILED DESCRIPTION OF THE INVENTION

In the first aspect, the present invention relates to a radical curable coating composition comprising the following compounds:
from 10 wt % to 70 wt %, based on the total weight of the coating composition, of one or more compounds A, each compound A comprising a poly(trimethylene ether) moiety and one or two (meth)acrylate groups; wherein the poly(trimethylene ether) moiety is incorporated into compound A by a condensation reaction of a poly(trimethylene ether) glycol with an (meth)acrylate compound selected from the group consisting of (meth)acrylic acid, (meth)acryloyl chloride, and alkylesters thereof, the poly(trimethylene ether) glycol having a number average molecular weight Mn, measured by GPC with polystyrene as the standard, of from 900 to 5000 Dalton,
from 30 wt % to 90 wt %, based on the total weight of the coating composition, of one or more (meth)acrylate compounds B different from the one or more compounds A, and wherein each compound B comprises two or more (meth)acrylate groups, wherein the one or more (meth)acrylate compounds B, combined, have a viscosity of at most 10000 mPa·s at 25° C.; and have a weight average molecular weight of at most 4000 Dalton, preferably at most 1000 Dalton, and
from 0 wt % to 25 wt %, based on the total weight of the coating composition, of one or more other compounds C, different from compounds A and B.

The composition of the first aspect is, at least partially, curable by the action of free-radicals by virtue of compounds A and B being polymerizable by the action of free-radicals. For instance, it can be cured by an electron beam, by the combination of a photoinitiator, which may be comprised in compound C, and actinic radiations. The actinic radiation may, for example, comprise near-infrared radiation, ultra-violet radiations at a wavelength of from 200 to 400 nm or visible light at a wavelength of from 400 to 450 nm (e.g., generated by an LED), or by thermally generated radicals (e.g., originating from the thermal decomposition of a thermal radical initiator such as a peroxide or an azo compound). With UV light radiation is meant irradiation via a ultraviolet light source including high or low-pressure mercury lamps, cold cathode tubes, xenon lamps, black lights, ultraviolet lasers, flash lights, and LED light sources. Typically the wavelength of a UV light source is between 240 and 379 nm. Typically, the wavelength of suitable visible light source is between 380 and 500 nm, preferably from 380 to 405 nm. With radiation using LED light sources is meant irradiation via a light-emitting diode source, whereby a semiconductor light source is used. Typically a wavelength of 365, 385, 395 or 405 nm is used.

The composition of the first aspect is preferably liquid at 25° C. For facilitating coating of a substrate, e.g., wood, with the composition at a sufficiently high rate, preferably, it has a viscosity below 7000 mPa·s at 25° C. For instance, it may have a viscosity below 5000 mPa·s at 25° C., preferably below 2500 mPa·s at 25° C. or below 1000 mPa·s at 25° C. Such embodiments have the advantage of providing a coating composition that is easy to apply by various techniques. This last range of viscosities is advantageous for using the composition to coat a substrate, e.g., a wood substrate, by repetitively applying the composition on a surface of the substrate followed by curing of the composition, then sanding of the surface, thereby forming a “sealed” layer of the substrate, e.g., the wood. Subsequently, a top coating of the composition may be formed by applying a further layer, i.e., the top coat layer.

In coating applications, viscosities of the compositions are typically between 100 mPa·s to 10 000 mPa·s at 25° C. depending on the method used to apply the coating.

Viscosities are measured with a rotational viscosimeter (cone and plate) according to DIN EN ISO 3219 with shear rate 20 s⁻¹ at 25° C.

It was surprisingly found that the composition combine a low viscosity and a high reactivity before cure with excellent coating properties after curing in terms of adhesion, abrasion and scratch resistance as well as stain resistance, even without the use of urethane acrylates.

Herein, compound A, which have a number average molecular weight Mn of from 900 to 5000 Dalton, was surprisingly found to have a low viscosity, and still provides a coating with properties that are comparably or even better than urethane acrylate based coatings. Urethane acrylates are typically highly viscous and, hence, need significant thinning using a high amount of reactive diluent. A balance is needed between a applicable viscosity and the final coating properties. The composition of the current invention is able to provide high quality coatings, such as wood coatings, limiting the amount of diluent needed.

Therefore, even for compositions in accordance with embodiments of the present invention having a large concentration of A, a low viscosity may be achieved. Especially when such coating made of the composition of current invention is used as an a layer below the top layer, properties such as stain and solvent resistance are maintained, even when there is damage of the top layer.

In preferred embodiments, the composition comprises at most 10 wt %, preferably at most 6 wt %, more preferably at most 1 wt %, yet more preferably at most 0.1 wt %, urethane (meth)acrylates. For instance, it may be free of urethane(meth)acrylates.

In embodiments, the poly(trimethylene ether) glycol reacted to incorporate the poly(trimethylene ether) moiety in compound A has a polydispersity D, measured by GPC, i.e., gel permeation chromatography, with polystyrene as the standard and THF (tetrahydrofuran) as the elution solvent, of at least 1.5 and preferably at most 3.4, preferably at least 1.6 and at most 2.5.

In embodiments, the biocarbon content of the ensemble of the one or more compounds A is more than 5%, preferably above 30%, more preferably above 50%, even more preferably above 60%, by weight of the total carbon content of the sum of all compounds A, wherein the biocarbon content is measured using the accelerated mass spectrometry protocol described in the standard ASTM D 6866-22.

In embodiments, the biocarbon content of the ensemble of the one or more (meth)acrylate compounds B totalizes more than 5%, preferably above 30%, more preferably above 50%, even more preferably above 60%, by weight of the total carbon content of the sum of all compounds B, wherein the biocarbon content is measured using the accelerated mass spectrometry protocol described in the standard ASTM D 6866-22.

In embodiments, the biocarbon content of the composition is more than 5%, preferably above 30%, more preferably above 50%, even more preferably above 60%, by weight of the total carbon content of the composition, wherein the biocarbon content is measured using the accelerated mass spectrometry protocol described in the standard ASTM D 6866-22.

Currently, there exist at least two different techniques for measuring the 14° C. content of a sample (i) by liquid scintillation counting or (ii) by mass spectrometry in which the sample is transformed in CO₂ and then reduced to graphite for analysis in the mass spectrometer to separate the ¹⁴C atoms from the ¹²C atoms and determine their ratio. All these methods for measuring the ¹⁴C content of substances are clearly described in the American standards ASTM D 6866 or ASTM D 7026 as well as in the European standards EN 16785 or EN 16640.

The values of the biobased carbon content according to his invention are measured using the accelerated mass spectrometry protocol described in the standard ASTM D 6866-22.

In embodiments, each compound A is formed from the poly(trimethylene ether) glycol having a number average molecular weight Mn, measured by GPC with polystyrene as the standard and THF (tetrahydrofuran) as the elution solvent, of from 900 to 5000 Dalton. The poly(trimethylene ether) (meth)acrylate compound A is obtainable by a condensation reaction of 1,3 poly(trimethylene ether) glycol (which can be biobased) and a (meth)acrylate compound which is selected from the group consisting of (meth)acrylic acid, (meth)acryloyl chloride, and/or alkyl esters thereof. The alkyl ester thereof preferably has a formula of H₂C═C(R)CO₂—R¹—COOH), or H₂C═C(R)CO₂—R¹—Cl, wherein R is H or CH₃, R¹ is a divalent linear alkyl radical having in the range of form 1 to 20, preferably 1 to 5, carbon atoms, a divalent branched alkyl radical having in the range of from 3 to 20 carbon atoms, or a divalent radical having cycloalkyl radical having in the range of from 5 to 10 carbon atoms.

For each compound A, the 1,3 poly(trimethylene ether) glycol may be obtained biochemically from a renewable source. This can be via a fermentation process using a renewable biological source such as e.g. corn feed stock. Examples of commercially available biobased 1,3 poly(trimethylene ether) glycol can be obtained by WeylChem under the tradename Velvetol® and are e.g. described in patent application WO2010/074805.

For each compound A, the condensation reaction, or esterification, is preferably carried out by reacting 1,3 poly(trimethylene ether) glycol with a stoichiometric excess of (meth)acrylate groups present on the (meth)acrylate compound selected from the group consisting of (meth)acrylic acid, (meth)acryloyl chloride, and/or alkyl esters thereof. The reactants are generally used in proportions corresponding to an equivalent ratio of (meth)acrylate groups to alcohol groups of the 1,3 poly(trimethylene ether) glycol of between 2.0:1.0 and 2.2:1.0.

Preferably each of the poly(trimethylene ether) (meth)acrylate compound A obtainable by the condensation reaction, comprises at least 90 wt %, more preferably at least 95 wt %, or at least 99 wt % of poly(trimethylene ether) di-(meth)acrylate in view of the total poly(trimethylene ether) (meth)acrylate compound A.

For preparation of each of the poly(trimethylene ether) (meth)acrylate compound A having at most two (meth)acrylate groups, 1, 3 poly(trimethylene ether) glycol can be contacted, preferably in the presence of a gas, with the (meth)acrylate compound at a temperature from about 25° C. to about 250° C. The process can be carried out at atmospheric pressure or under vacuum. During reaction, water is formed and can be removed in the inert gas stream or under vacuum to drive the reaction to completion.

For each compound A, to facilitate the reaction of poly(trimethylene ether) glycol with the (meth)acrylate compound, an esterification catalyst is generally used, preferably a mineral acid catalyst. Examples of acid catalysts include but are not restricted to sulfuric acid, aryl or alkyl sulfonic acid, triflic acid, hydriodic acid, and heterogeneous catalysts such as zeolites, heteropolyacid, amberlyst, dialkyl tin dilaurate, titanium alkoxide and ion exchange resin. Preferred esterification acid catalysts are selected from the group consisting of sulfuric acid, p-toluenesulfonic acid, methanesulfonic acid, triflic acid, dialkyl tin dilaurate, titanium alkoxide, and hydroiodic acid. The particularly preferred acid catalyst are sulfuric acid, triflic acid and ion exchange resins. The amount of catalyst used can be from about 0.01 wt % to about 10 wt % of the reaction mixture, preferably from 0.1 wt % to about 5 wt %, and more preferably from about 0.2 wt % to about 2 wt %, of the reaction mixture. To prevent free radical polymerization of (meth)acrylic esters of poly(trimethylene ether) glycol, inhibitors are used, such as 4-methoxyphenol. Examples of inhibitors include but are not restricted to alkyl phenols, alkoxyphenol, hydroxybenzyl alcohol and hydroquinone. The amount of the inhibitor can be from about 0.001 to 5 wt % of the product. A preferred range is from about 0.01 to 2.0 wt %. The esterification reaction can be conducted in the presence or absence of a solvent. Examples of solvents include but are not restricted to acetonitrile, cyclohexane, hexane, methylcyclohexane, heptane, octane, tetrahydrofuran, toluene and xylene. A preferred solvent is acetonitrile or toluene. The amount of solvent used can be from about 0 wt % to about 100 wt % of the reaction mixture, preferably from 20 wt % to about 100 wt %, and more preferably from about 50 wt % to about 100 wt %, of the reaction mixture.

In embodiments, a weight average molecular weight of the ensemble of the one or more (meth)acrylate compounds B is at most 4000 Dalton, preferably at most 1000 Dalton. In embodiments, each compound B has a weight average molecular weight of at most 4000 Dalton, preferably at most 1000 Dalton. For monodispersed compounds such as monomers, this weight average molecular weight is the molecular mass as calculated from the molecular formula. For polydisperse compounds such as oligomers or polymers, this weight average molecular weight is determined by GPC with PS standard using THE as eluent.

Compound B is typically a (meth)acrylated diluent. In embodiments, the one or more (meth)acrylate compounds B, combined, have a viscosity of at most 5000 mPa·s, preferably at most 4000 mPa·s, at 25° C. In embodiments, each compound B comprises two or three (meth)acrylate groups.

Some of the one or more (meth)acrylate compounds B may comprise a poly(trimethylene ether) moiety, e.g., having a Mn, measured by GPC with polystyrene as the standard, below 900 or above 5000. The same or other of the one or more (meth)acrylate compounds B may comprise a poly(trimethylene ether) moiety which is not incorporated into compound B by a condensation reaction of a poly(trimethylene ether) glycol with an (meth)acrylate compound selected from the group consisting of (meth)acrylic acid, (meth)acryloyl chloride, and alkylesters thereof. For instance, the moiety can be incorporated into compound B by a reaction involving the formation of an urethane linkage.

Preferably, none of the one or more (meth)acrylate compounds B comprises a poly(trimethylene ether) moiety.

In embodiments, each compound B is selected from ethoxylated and/or propoxylated neopentylglycoldi(meth)acrylate, di-trimethylolpropanetri(meth)acrylate, bisphenol A di(meth)acrylate and the ethoxylated and/or propoxylated derivatives thereof, 1,6-hexanediol di(meth)acrylate, 1,6-hexanediol ethoxylate di(meth)acrylate, 1,6-hexanediol propoxylate di(meth)acrylate, dipropyleneglycoldiacrylate, dipropyleneglycol ethoxylate di(meth)acrylate, dipropyleneglycol propoxylate di(meth)acrylate, tripropyleneglycoldi(meth)acrylate, tripropyleneglycol ethoxylate di(meth)acrylate; tripropyleneglycol propoxylate di(meth)acrylate, pentaerythritol ethoxylate tri(meth)acrylate, pentaerythritoltriacrylate, pentaerythritol propoxylate tri(meth)acrylate, trimethylolpropanetriacrylate, trimethylolpropane ethoxylate tri(meth)acrylate, trimethylolpropane propoxylate tri(meth)acrylate, glycerol tri(meth)acrylate, glycerol ethoxylate triacrylate, and glycerol propoxylate triacrylate.

Preferably, each compound B is selected from 1,6-hexanediol di(meth)acrylate, 1,6-hexanediol ethoxylate di(meth)acrylate, 1,6-hexanediol propoxylate di(meth)acrylate, dipropyleneglycoldi(meth)acrylate, dipropyleneglycol ethoxylate di(meth)acrylate, dipropyleneglycol propoxylate di(meth)acrylate, tripropyleneglycoldi(meth)acrylate, tripropyleneglycol ethoxylate tripropyleneglycol propoxylate di(meth)acrylate, pentaerythritol ethoxylate tri(meth)acrylate, pentaerythritoltri(meth)acrylate, pentaerythritol propoxylate tri(meth)acrylate, trimethylolpropanetri(meth)acrylate, trimethylolpropane ethoxylate tri(meth)acrylate, trimethylolpropane propoxylate tri(meth)acrylate, and glycerol propoxylate triacrylate.

In embodiments, the amount of the one or more compounds A is from 15 wt % to 60 wt %, preferably from 20 wt % to 50 wt %, and the amount of the one or more (meth)acrylate compound B is from 40 wt % to 85 wt %, preferably from 50 wt % to 80 wt %, based on the total weight of the coating composition.

The composition can be cured thermally if compound C comprises a radical initiator that is activated thermally.

In embodiments, component C may comprise one or more radical initiators. Each radical initiator can be selected from thermal initiators and photoinitiators. Preferably one or more photoinitiators are used.

Typically, when present, the radical initiators are preferably present from 0.1 wt % to 10 wt % of the total weight of the coating composition.

Examples of suitable UV photoinitiators are benzophenone, benzoin ethyl ether, benzoin methyl ether, anthraquinone, 2-methyl-1-[4-(methylthio)phenyl]-2-morpholinopropan-1-one, 2-hydroxy-2-methyl-1-phenylpropane-1-one, and combinations thereof.

Examples of suitable visible light photoinitiators are bis(.eta.5-2,4-cylcopentadien-1-yl)-bis(2,6-difluoro-3-(1H-pyrrol-1-yl)-phenyl) titanium (Irgacure 784), and bis(2,4,6-trimethylbenzoyl)-phenylphosphineoxide (Irgacure 819).

The composition can also be cured “thermally” via polymerization initiated by free-radical generating agents, including peroxide and azo-type initiators. Peroxide initiators include diacylperoxides, hydroperoxides, ketone peroxides, peroxyesters, peroxyketals, dialkyl peroxides, alkyl peresters and percarbonates and the like, used alone or with redox systems. Examples of these peroxides include methyl ethyl ketone peroxide (MEKP), methyl isobutyl ketone peroxide (MIBK), benzoyl peroxide (BPO) and cumene hydroperoxide (CHP). Combinations of two or more peroxides may be used to cure the resin. Azo-type initiators include azobisisobutyronitrile (AIBN) and related compounds.

In embodiments, compound C can comprise a solvent, e.g. a biobased solvent, to decrease the viscosity. The latter is not preferred. The biobased carbon content may be higher when no solvent is added to the composition.

When present, the solvent may be present in an amount of at most 25 wt %, preferably at most 15 wt %, more preferably at most 10 wt %, more preferably at most 5 wt %, yet more preferably at most 2 wt %, even more preferably at most 1 wt %, and most preferably at most 0.2 wt % of the composition.

In embodiments, compound C can comprise one or more (meth)acrylate compounds D different from the one or more compounds A or B, and wherein each compound D comprises only one (meth)acrylate groups. In embodiments, a weight average molecular weight of the one or more (meth)acrylate compounds D is at most 4000 Dalton, preferably at most 1000 Dalton. In embodiments, an average molecular weight of each of the one or more (meth)acrylate compounds D is at most 4000 Dalton, preferably at most 1000 Dalton. In embodiments, each compound D is selected from (meth)acrylic acid, beta-carboxyethyl acrylate, butyl(meth)acrylate, methyl(meth)acrylate, isobutyl(meth)acrylate, 2-ethylhexyl(meth)acrylate, cyclohexyl(meth)acrylate, n-hexyl (meth)acrylate, isobornyl (meth)acrylate, isooctyl (meth)acrylate, n-lauryl (meth)acrylate, octyl/decyl (meth)acrylate, 2-hydroxyethyl(meth)acrylate, phenoxyethyl(meth)acrylate, nonylphenolethoxylate mono(meth)acrylate, 2-(-2-ethoxyethoxy)ethyl(meth)acrylate, 2-butoxyethyl (meth)acrylate, N-vinyl pyrrolidone, phenylglycidylether(meth)acrylate and the ethoxylated or/and propoxylated derivatives thereof, the (meth)acrylates obtained from the esterification with (meth)acrylic acid of aliphatic glycidyl ethers, especially those wherein the alkyl chain comprises from 6 to 24 carbon atoms, more preferably from 8 to 18 carbon atoms, and/or of glycidyl esters of saturated and unsaturated carboxylic acids, especially the glycidyl esters of long chain alkyl carboxylic acids wherein the alkyl chain comprises from 6 to 24 carbon atoms, more preferably from 8 to 18 carbon atoms.

When present, compounds D may be present in an amount up to 25 wt %, preferably at most 15 wt %, more preferably at most 10 wt %, more preferably at most 5 wt %, yet more preferably at most 2 wt %, even more preferably at most 1 wt %, and most preferably at most 0.2 wt % of the composition.

In embodiments, compound C can comprise compounds E1 having a poly(trimethylene ether) moiety and only one (meth)acrylate group, wherein the poly(trimethylene ether) moiety is incorporated into compound E1 by a reaction of a poly(trimethylene ether) glycol, the poly(trimethylene ether) glycol having a number average molecular weight Mn, measured by GPC with polystyrene as the standard, below 900 Dalton, e.g. below 800 Dalton.

When present, compounds E1 may be present in an amount up to 25 wt %, preferably at most 15 wt %, more preferably at most 10 wt %, more preferably at most 5 wt %, yet more preferably at most 2 wt %, even more preferably at most 1 wt %, and most preferably at most 0.2 wt % of the composition. Preferably, no compounds E1 is present.

In embodiments, compound C may comprise compounds E2 having a poly(trimethylene ether) moiety and only one (meth)acrylate groups; wherein the poly(trimethylene ether) moiety is incorporated into compound E2 by a reaction of a poly(trimethylene ether) glycol, the poly(trimethylene ether) glycol having a number average molecular weight Mn, measured by GPC with polystyrene as the standard above 5000 Dalton, e.g. above 5500 Dalton. When present, compounds E2 may be present in an amount up to 25 wt %, preferably at most 15 wt %, more preferably at most 10 wt %, more preferably at most 5 wt %, yet more preferably at most 2 wt %, even more preferably at most 1 wt %, and most preferably at most 0.2 wt % of the composition.

In embodiments, compound C may comprise a polymer compound F having no ethylenically unsaturated groups. Examples of such polymers are saturated polyesters, halogenated or not, hydrocarbons (such as styrene based hydrocarbon resins), styrene allyl alcohols, acrylics (such as acrylic (co)polymers), (poly)urethane resins, polyethylenevinylacetate resins, polyvinylchloride resins, chlorinated polyolefin resins and/or ketone resins. Other types of polymers can be biobased polymers such as polymers and copolymers of lactic acid, cellulose esters (such as cellulose acetate, cellulose propionate, cellulose butyrate and combinations thereof), polyhydroxyalkanoates (e.g. polyhydroxybutyrate and copolymers), lignin derivatives, hemicellulose derivatives, etc. When present, compounds F are preferably present in an amount up to 25 wt %, preferably at most 15 wt %, more preferably at most 10 wt %, more preferably at most 5 wt %, yet more preferably at most 2 wt %, even more preferably at most 1 wt %, and most preferably at most 0.2 wt % of the composition.

In embodiments, compound C may comprise one or more inhibitors G. Examples of suitable inhibitors include but are not limited to phenolic inhibitors such as hydroquinone (HQ), methyl hydroquinone (THQ), tert-butyl hydroquinone (TBHQ), parabenzoquinone (BQ), 4-tert butyl catechol, di-tert-butyl hydroquinone (DTBHQ), hydroquinone monomethyl ether (MEHQ), 2,6-di-tert-butyl-4-methylphenol (BHT) and the like. They may also include phosphines, like triphenylphosphine (TPP) and other materials such as tris-nonylphenylphosphite (TNPP), phenothiazine (PTZ), and triphenyl antimony (TPS). When present, inhibitors are preferably present in an amount up to 0.5 wt %, in particular from 0.0001 to 0.2 wt %, and preferably from 0.01 to 0.1 wt % of the composition.

Photostabilizers can be classified as UV absorbers (UVAs), deactivators (quenchers), hydroperoxide decomposers, and radical scavengers known as hindered amine light stabilizers (HALS).

In embodiments, compound C may comprise one or more UV absorber (UVA) and/or a hindered amine light stabilizer (HALS) H. The UVAs protect the polymers by absorbing destructive UV radiation, while the HALS material protects by reacting with the free radicals that occur after a high-energy UV photon breaks a chemical bond in a polymer.

Examples of UVAs are benzotriazoles such as Tinuvin® 328, Tinuvin® 1130, Tinuvin® 900, Tinuvin® 99-2, and Tinuvin® 384-2, triazines such as Tinuvin® 400, Tinuvin® 405, Tinuvin® 460, Tinuvin® 477, and Tinuvin® 479, and benzophenones such as Tinuvin® 531.

Examples of HALS are Tinuvin® 123, Tinuvin® 144, and Tinuvin® 292, 2,2,6,6-tetramethylpiperidine and 2,6-di-tert-butylpiperidine.

Photostabilizers, when present in compound C, may be used in an amount of from 0.1 to 5.0, preferably from 0.5 to 2.5 wt % of the composition.

Compound C may comprise further additives such as fiber wetting agents e.g. functionalized silanes; and (acidic) adhesion promotors.

Compound C may comprise other conventional ingredients including pigments, dyes, heat stabilizers, defoamers, leveling agents, fillers, sedimentation inhibitors, antioxidants and the like introduced at any stage of the preparation process or subsequently.

Any feature of the first aspect can be as correspondingly described in any of the other aspects.

In the second aspect, the present invention relates to a use of a radical curable coating composition according to any embodiments of the first aspect, as part of a substrate coating, as one or more a substrate coating. These on or more layers can be below a top coat layer, which can have a different composition as the radical curable composition of the first aspect.

Such embodiments have the advantage of providing a coating system with improved properties, such as improved adhesion, flexibility and durability.

In embodiments, the radical curable coating composition can be at least partially cured. In embodiments, the radical curable coating composition can be used between a primer of the substrate coating and the top coat layer of the substrate coating.

In preferred embodiments, the substrate coating is on a wood substrate.

In embodiments, the substrate coating is a wood coating.

Any feature of the second aspect can be as correspondingly described in any of the other aspects.

In the third aspect, the present invention relates to a method of forming a coating comprising applying a layer of the radical curable coating composition according to any one of the embodiments of the first aspect, to at least a portion of a substrate and submitting the coated substrate to curing conditions.

The application temperature is the temperature the radical curable coating composition has when the composition is brought in contact with a substrate. In most cases the application temperature is room temperature, e.g., 20° C., but sometimes the coating composition is brought in contact with a substrate that is at a higher temperature.

When compound C comprises a thermal radical initiator, i.e., a radical initiator that is activated thermally, the curing conditions may comprise applying a temperature adapted for forming radicals from the thermal radical initiator. Preferably, the temperature is not raised above 300° C. This is advantageous as it avoids thermal decomposition of the composition. It also avoids unnecessarily high thermal budgets. It further avoids degradation of the substrate.

In embodiments, the curing conditions may be selected from peroxide curing, LED curing, UV curing and/or electron beam curing.

In embodiments, the substrate may be selected from the group consisting of wood, plastic, leather, metal, ceramic, paper and mineral substrates.

In preferred embodiments, the substrate is a wood substrate.

In embodiments, the step of applying one or more layers of a radical curable composition is preceded by a step of applying a primer coat. In embodiments, the primer coat is applied at a coat weight of from 2 to 50 g m⁻², preferably of from 5 to 20 g m⁻².

In embodiments, the step of applying the primer coat is preceded by a step of sanding the substrate.

In embodiments, the layer of the radical curable coating composition according to any one of the embodiments of the first aspect has a coat weight of at least 10 g m⁻², e.g., from 10 to 75 g m⁻², or from 10 to 25 g m⁻². For parquet coatings it may be desirable to have a total sealer coating weight of from 60 to 75 g m⁻². Such thick coat is difficult to be applied in one step. Moreover, the overall mechanical properties improve when several layers are applied in steps.

In embodiments, the step of applying one or more layers of a radical curable composition is followed by a step of applying a top coat layer.

In embodiments, the step of applying the top coat layer is preceded by a step of sanding the top surface of the cured radical curable coating composition.

In preferred embodiments, the cured radical curable coating comprises at least one, e.g., a plurality of, layers, preferably from two to five layers, more preferably from three to four layer, of the cured radical curable coating composition.

In embodiments, the step of applying one or more layers of a radical curable composition comprises repetitively:
applying the composition on a surface of the substrate followed by curing of the composition, then
optionally sanding of the surface.

Preferably, at least the first and the last applied layer are sanded.

These embodiments are preferred when the substrate is wood. In these embodiments, a “sealed” layer of the substrate, e.g., the wood, may be formed. Subsequently, a top coat layer may be formed on the sealed layer.

In embodiments, the layer of the radical curable coating composition according to anyone of the embodiments of the first aspect is applied via roller coating.

In embodiments, the cured free-radical curable composition may have an elongation at break of at least 1%, preferably at least 5%, and more preferably at least 6%, and even more preferably at least 9%.

Young's modulus or tensile modulus of elasticity is a mechanical property that provides an index for the degree of stiffness of a solid material. It defines the relationship between tensile stress (force per unit area, pressure units) and tensile strain (relative deformation, dimensionless) of a material for small uniaxial deformation. Young's modulus (Ex) is the ratio of the tensile stress to the tensile strain, and is reported in pressure units. The ultimate tensile elongation (UTE) or elongation at break describes how much the material can be deformed before failure and is defined as the percentage change in length from an non-elongated state of the material (i.e., no force applied) to the elongated state of the material where failure of the material occurs. The measurement is carried out at a temperature of 23° C. and a relative humidity of 30%.

Preferably, the T_{g} of the cured radical curable composition may be more than 20° C., preferably at least 25° C., yet more preferably at least 30° C. Typically, it is lower than 160° C., such as lower than 140° C.

The T_{g} is determined using dynamical mechanical thermal analysis (DMTA) on freestanding films of the cured radical curable composition, as described by the standard method ASTM D4065-01 (Standard test method for the assignment of the glass transition temperature by Dynamic Mechanical Analysis). Herein, the T_{g} is determined as the temperature at the maximum of the loss factor curve (i.e., T(tan δₘₐₓ)).

In embodiments, the cured radical curable composition may have a Young's modulus of at least 1 MPa, such as at least 5 MPa, e.g., at least 10 MPa, at 25° C.

The cured radical curable composition according to any embodiment of the first aspect may form a coating on the substrate. The coating may have a thickness of from 5 μm to 5 cm. A coating of from 5 mm to 5 cm can be advantageous for coating heavy duty outdoor substrates. The curing of the radical curable composition being exothermic, obtaining a coating of such high thicknesses is typically accompanied by the release of much heat. For high thicknesses, it is, therefore, preferred if at least some of the ethylenically unsaturated polymerizable moieties comprise a methacrylate group, as it increases the temperature at which cleavage spontaneously occurs.

Any feature of the third aspect can be as correspondingly described in any of the other aspects.

In the fourth aspect, the present invention relates to an entity composed of a substrate that is in contact with the radical curable coating composition according to any one of the embodiments of the first aspect.

Any feature of the fourth aspect can be as correspondingly described in any of the preceding aspects.

The present invention will now be described in details with reference to the following non-limiting examples which are by way of illustration only.

### Examples

### Techniques Used to Determine the Properties of the Compositions and Coatings Formed Therewith

### Viscosity

The shear viscosity η of the liquid resins is measured according to DIN EN ISO 3219 using a rotational rheometer at a shear rate of 20 s⁻¹ and a temperature of 23° C.

### Coating Preparation on Glass or Paper Substrate

In order to determine the glass transition and tensile properties, the liquid UV-curable compositions were applied using a bar coater on a glass substrate cleaned in front with acetone and isopropanol. The coating layers were cured using a belt conveyor running at a speed of 5 m min⁻¹ and equipped with two UV lamps in series, respectively a 80 W cm⁻¹ Ga-doped medium-pressure mercury vapor (Hg) lamp followed by a 80 W cm⁻¹ medium pressure Hg lamp. After curing, the coatings were recovered from the glass substrate as a free-standing film.

For testing the reactivity and solvent resistance of coatings formed with the compositions a similar procedure was performed wherein glass or non-absorbing paper (Leneta) was used as substrate, and wherein the coatings were not removed from the substrate.

### Determination of the Glass Transition Temperature by Dynamic Mechanical Analysis

The glass transition temperature (T_{g}) marks the boundary between the glassy, rigid state and the softer relaxed state of a polymer or polymer network which can be rubbery or even fluid.

In these examples, dynamical mechanical thermal analysis (DMTA) was used on freestanding films formed using the method described above in “Coating preparation on glass or paper substrate”, as described by the standard method ASTM D4065-01 (Standard test method for the assignment of the glass transition temperature by Dynamic Mechanical Analysis). DMTA measurements were conducted using a DMA Q800 (TA Instruments) instrument in tensile mode. The dimensions of the samples between the clamps were typically 11 mm×8.0 mm×0.04 mm. A periodic strain deformation was applied with an amplitude of 30 μm at a frequency of 1 Hz. The viscoelastic properties are measured following a temperature profile increasing from −50 to 200° C. at a heating rate of 3° C. per minute. The T_{g} is determined as the temperature at the maximum of the loss factor curve (i.e., T(tan δₘₐₓ))

### Tensile Properties

Young's modulus or tensile modulus of elasticity is a mechanical property that provides an index for the degree of stiffness of a solid material. It defines the relationship between tensile stress (force per unit area, pressure units) and tensile strain (relative deformation, dimensionless) of a material for small uniaxial deformation. Young's modulus (E_{Y}) is the ratio of the tensile stress to the tensile strain, and is reported in pressure units. The ultimate tensile elongation (UTE) or elongation at break describes the resistance of the material against failure, and is defined as the percentage change in length from an non-elongated state of the material (i.e., no force applied), to the elongated state of the material wherein rupture of the material occurs. Tensile properties are reported for freestanding films formed using the method described above in “Coating preparation on glass or paper substrate”. The properties were measured at a temperature of 23° C. according to one of the following standard methods for the determination of tensile properties, ASTM D638 (Standard Test Method for Tensile Properties of Plastics), ASTM D882 (Standard Test Method for Tensile Properties of Thin Plastic Sheeting), also referred to as ISO527-1 (Plastics—Determination of tensile properties).

### Reactivity

For successful application, the UV-curable composition should demonstrate a high reactivity upon exposure to UV-light. In order to assess the reactivity properties, the liquid UV-curable compositions were applied with a thickness of 20-25 μm onto white non-absorbing paper. UV-curing was conducted in a similar way as described earlier for the glass substrate. The conveyer speed is varied in order to determine the maximum conveyer speed to be used to obtain a thoroughly cured film. The level of curing is assessed by applying some fine graphite powder on the coating surface, rubbing with a finger and then with a cotton. As long as a dark mark persist after removing the excess graphite powder, the film is not well cured and the conveyer speed must be reduced to increase UV exposure. The UV-dose (expressed as the conveyer speed (m min⁻¹) at a fixed power of the UV lamp) required to pass the two tests is referred to as the reactivity of the coating.

### Solvent Resistance

The solvent rub test is used to evaluate with solvent resistance. The test involves rubbing the surface of a cured coating with a cotton soaked with acetone until failure or breakthrough of the film occurs. The rubs are counted as a double rub (one rub forward and one rub backward amounts to a double rub). A high solvent resistance (more than a hundred double rubs) is advantageous to ensure a good protection of the coating and the substrate against any household or industrial product spillage.

### Coating Preparation on Wood

Beech wood was used as the substrate for testing the coating adhesion, the scratch resistance and the abrasion resistance. On the beech wood, first, a primer was applied. In this example, the primer was Ucecoat 7177, which was applied by a roller coater at an amount, measured before drying of the primer, of 20 g m⁻². Subsequently, the primer was dried at 40° C., and, next, cured using UV radiation from a 80 W cm⁻¹ Hg lamp at a rate of 5 m min⁻¹.

On the primer, three layers of coating formed from the composition were applied, wherein for each layer, an amount of from 20 to 25 g m⁻² of the composition (before curing) was applied. A first layer of coating was cured using UV radiation from a 120 W cm⁻¹ Hg lamp at a rate of 10 m min⁻¹, followed by sanding at a grit of P240. Said sanding improves adhesion between the different layers of coating. A second layer was formed by applying the composition on the first, sanded, layer of coating and curing the layer by UV radiation from a 40 W cm⁻¹ Hg lamp at a rate of 10 m min⁻¹. A third layer was formed by applying the composition on the second layer of coating and curing the layer by UV radiation from a 120 W cm⁻¹ Hg lamp at a rate of 10 m min⁻¹, followed by sanding at a grit of P240. Finally, a conventional radiation curable top coat layer was formed by applying 10 g m⁻² onto the third layer, followed by curing at a rate of 5 m min⁻¹ using an 80 W cm⁻¹ Ga+Hg lamp.

### Coating Adhesion

Coating adhesion was evaluated according to ASTM D3359 (or equivalently ISO2409) which covers a procedure for assessing the adhesion of a coating to a substrate by applying and removing pressure-sensitive tape over cuts made in the film. A wood coating was prepared according to the procedure described in “Coating preparation on wood” above. A square lattice pattern was made in the coating with a sharp cutting tool. Pressure-sensitive adhesive tape (Tesa 4104) was applied over the lattice and then removed rapidly. Based on the number of squares removed by the tape, a value of adhesion was given: 0B (100% of the squares removed), 1B (65-35% of the squares removed), 2B (35-15% of the squares removed), 3B (15-5% of the square removed), 4B (less than 5% of the squares removed, 5B (0%).

### Scratch Resistance

A wood coating was prepared according to the procedure described in “Coating preparation on wood” above.

### 1. Pencil Test (Erichsen)

Erichsen pencil test is a common method for the measurement of the hardness of protective coatings. The estimated or known spring tension on the instrument (Model 318) is set with the help of a slider. Holding the instrument upright and placing the point of the stylus (Bosch, 0.75 mm) on the test substrate, one subsequently draws a 5 to 10 mm long line at a speed of approximately 10 mm s⁻¹. The stylus should produce a scratch which is barely visible with the naked eye. If the spring force is too high, the scratch is too clearly visible; if it is too low, no scratch appears. The coating hardness corresponds to the applied force (in Newton) which leads to the appearance of a first visible scratch in the coating. A higher hardness means a better protection against any exposure to scratching conditions during storage and use.

### 2. Coin Test (Hamberger-Höbel)

The coating is fitted in the Hamberger-Höbel tester. The apparatus is equipped with a screw that can be turned in such a way that the pressure of a coin on the coating can be varied. The load is increased stepwise until a scratch of a few centimeters appears on the coated surface. The higher the load value, the better the scratch resistance. The scratch resistance is expressed in Newton.

Abrasion Resistance (Taber Abrasion with Grit Feed Method)

A wood coating was prepared according to the procedure described in “Coating preparation on wood” above.

This method is based on the standard test method ASTM F510-93 and uses a Taber abrader 5150 with leather-covered wheels (S-39); sand used in the test is of the type Alodur ESK 240 EN 14354 from Treibacher. All equipment and substrates are conditioned at least 24 hours in the conditioned room (21±1° C., 50±5% relative humidity) before testing. The coated substrates are abraded in steps of 500 cycles until spots appear where the coating is completely removed (initial point). The initial point is reached when blues spots are formed on the test specimen after application of a methylene blue solution. After determination of the initial point, abrasion is carried out for another 500 cycles. Again, a methyleneblue solution is applied for visual comparison. Abrasion is followed by recording the mass loss (in mg, accuracy of ±0.1 mg) after each 500 cycles step. The slope estimated upon linear regression of the mass loss data against the number of cycles provides the rate of abrasion.

Examples of (Meth)Acrylates for Use in Radical Curable Coating Compositions Commercial poly(trimethylene ether) glycol Velvetol® H250, H500, H1000, H2000, and H27000 were used as starting materials.

TABLE 0
summarizes their characteristics.

| Velvetol ® | Mₙ (Da) | M_{w} (Da) | Ð | η (mPa s) |
|---|---|---|---|---|
| H250 | 462 | 600 | 1.30 | 112 |
| H500 | 965 | 1525 | 1.58 | 240 |
| H1000 | 1666 | 3065 | 1.84 | 510 |
| H2000 | 2877 | 6330 | 2.20 | 1725 |
| H2700 | 3710 | 8830 | 2.38 | 3215 |

Table 1 summarizes a range of diacrylated compounds, used in the examples of compositions in accordance with embodiments of the present invention. Herein, PPDA1000, PPDA2000 and PPDA2700 may be used as compound A as described in embodiments of the first aspect of the present invention. PPDA250 and PPDA500 may be used as compound B as described in embodiments of the first aspect of the present invention. The compounds comprise a poly-trimethylene ether moiety and two (meth)acrylate groups, that are formed by a condensation reaction of a poly(trimethylene ether) glycol, of which the commercial name is indicated as the poly(trimethylene ether) glycol precursor, with (meth)acrylic acid. The reaction was performed using techniques known in the art such as those described in WO2010074805. The reported number average molecular weight Mₙ, and the reported weight average molecular weight M_{w}, were measured by GPC with polystyrene as the standard and tetrahydrofurane (THF) as the elution solvent. The polydispersity Ð=M_{w}/Mₙ was derived therefrom. Viscosities, measured using the technique described above, are also provided in Table 1.

TABLE 1
Molar mass distribution and viscosity data of several di(meth)acrylated
poly(trimethylene ether) glycol compounds

| | Poly(trimethylene | Mₙ | M_{w} | | η |
|---|---|---|---|---|---|
| Compound | ether) glycol precursor | (Da) | (Da) | Ð | (mPa s) |
| PPDA250 | Velvetol ® H250 | 480 | 630 | 1.31 | 21 |
| PPDA500 | Velvetol ® H500 | 970 | 2930 | 3.02 | 160 |
| PPDA1000 | Velvetol ® H1000 | 1560 | 3005 | 1.93 | 385 |
| PPDA2000 | Velvetol ® H2000 | 2830 | 6590 | 2.33 | 2000 |
| PPDA2700 | Velvetol ® H2700 | 3530 | 9395 | 2.66 | 2940 |

Table 2 summarizes the glass transition temperatures and tensile properties for several coatings formed by forming a free-standing film using different compounds as described above under “Coating preparation on glass or paper substrate”. In this context, we define the glass transition temperature T_{g} as the temperature at which the loss factor curve reaches its maximum value (i.e. T(tan δₘₐₓ)). The Young's modulus E_{Y} as well as the elongation at break (UTE), were determined using the methods described above. These measurements were performed on various di(meth)acrylated poly(trimethylene ether) glycol compounds, some of which were previously described in Table 1. PPDA1000, PPDA2000 and PPDA2700 may be used as compound A as described in embodiments of the first aspect of the present invention. PPDA250 and PPDA500 may be used as compound B as described in embodiments of the first aspect of the present invention.

TABLE 2
Glass transition temperature and tensile properties
of coatings formed from several di(meth)acrylated
poly(trimethylene ether) glycol compounds

| Compound | T_{g} (° C.) | E_{Y} (MPa) | UTE (%) |
|---|---|---|---|
| PPDA250 | 14 | 93 | 7 |
| PPDA500 | −34 | 36 | 12 |
| PPDA1000 | −56 | 18 | 23 |
| PPDA2000 | −63 | 12 | 40 |
| PPDA2700 | −64 | 7 | 34 |

### Examples of Radical Curable Coating Compositions

Tables 3 and Table 4 summarize a range of compositions in accordance with embodiments of the present invention that were prepared using the (meth)acrylated poly(trimethylene ether) glycol compounds summarized in Table 1 and Table 2. The compositions may further contain EB5781 (commercial name is EBECRYL® 5781, Mn is 290 g/mol) which is a monomeric, low viscosity bio-based diacrylate with (Mw 268), and which is in accordance with compound B as described in embodiments of the first aspect of the present invention. The compositions may further contain OTA480 (commercial name EBECRYL® OTA480, Mn of 630 g/mol), which is a triacrylated reactive diluent based on a glycerol derivative, that is a compound B as described in embodiments of the first aspect of the present invention. The compositions may further contain DPGDA that is dipropylene glycol di(meth)acrylate, that is a compound B as described in embodiments of the first aspect of the present invention. The compositions may further contain a photoinitiator PI (a compound C) having a commercial name Additol® BCPK, which generates radicals on irradiation with UV light, and which contains benzophenone and 1-hydroxy-cyclohexylphenyl-ketone. Herein, for each composition, the amount of each compound in mol % contained in the composition is indicated. Table 3 and 4 also summarize the viscosity for each of the compounds used in the different compositions. Furthermore, Table 4 summarizes the viscosity as measured for the different compositions.

TABLE 3
Compositions in accordance with embodiments of the present
invention. The viscosity η at 23° C. is indicated
for each of the compounds.

| | η_{23° C.} | FTL | FTL | FTL | FTL |
|---|---|---|---|---|---|
| Compound | (mPa s) | 002 | 005 | 008 | 009 |
| PPDA2700 | 2940 | 50 | | | 50 |
| PPDA1000 | 385 | | 50 | 50 | |
| PPDA250 | 21 | | | | |
| EB5781 | 490 | | | 50 | 50 |
| OTA480 | 100 | | | | |
| DPGDA | 10 | 50 | 50 | | |
| Sum of the above | | 100 | 100 | 100 | 100 |
| Photoinitiator (BCPK) | | 4 | 4 | 4 | 4 |

TABLE 4
Compositions in accordance with embodiments of the present
invention. The viscosity η at 23° C. is indicated
for each of the compounds and each of the compositions.

| | η_{23° C.} | FTL | FTL | FTL |
|---|---|---|---|---|
| Compound | (mPa s) | 020 | 021 | 023 |
| PPDA2700 | 2940 | 30 | 30 | 40 |
| PPDA250 | 21 | | 40 | |
| DPGDA | 10 | 70 | 30 | 60 |
| Sum of the above | | 100 | 100 | 100 |
| Photoinitiator (BCPK) | | 4 | 4 | 4 |
| η_{23° C.} (mPa s) | | 94 | 120 | 183 |

Glass Transition and Tensile Properties, Reactivity and Solvent Resistance of Coatings Formed with the Radical Curable Coating Compositions

Table 5 summarizes the glass transition temperature and tensile properties, Table 6 the reactivity and solvent resistance of coatings prepared with the different compositions summarized in Table 3 and Table 4.

TABLE 5
Glass transition temperature and tensile properties for
coatings prepared with the different compositions in
accordance with embodiments of the present invention.

| Composition | T_{g} (° C.) | E_{Y} (MPa) | UTE (%) |
|---|---|---|---|
| FTL002 | 64 | 106 ± 4 | 35 ± 5 |
| FTL005 | 31 | 119 ± 6 | 20 ± 3 |
| FTL008 | 95 | 406 ± 26 | 6 ± 4 |
| FTL009 | 107 | 287 ± 12 | 6 ± 3 |
| FTL020 | 78 | 352 ± 17 | 11 ± 1 |
| FTL021 | 43 | 119 ± 8 | 11 ± 1 |
| FTL023 | 67 | 211 ± 16 | 23 ± 3 |

TABLE 6
Reactivity and solvent resistance of coatings formed from compositions
in accordance with embodiments of the present invention, applied
and cured on glass and paper as substrate.

| | Reactivity (40 W cm⁻¹ Hg) | Acetone |
|---|---|---|
| Composition | Belt speed (m min⁻¹) | double rubs |
| FTL002 | 20 | >100 |
| FTL005 | 20 | >100 |
| FTL008 | 20 | >100 |
| FTL009 | 20 | >100 |
| FTL020 | 20 | >100 |
| FTL021 | 20 | >100 |
| FTL023 | 20 | >100 |

Adhesion, Scratch and Abrasion Properties of Wood Coatings Prepared with the Radical Curable Coating Compositions.

TABLE 7
Coating adhesion, scratch and abrasion properties of coatings
prepared from compositions in accordance with embodiments of
the present invention, applied and cured on wood as substrate.

| | | Coin scratch | Pencil scratch | Taber-Grit feed |
|---|---|---|---|---|
| Compo- | Coating | resistance | resistance | Abrasion rate |
| sition | adhesion | (N) | (N) | (mg/100 cycles) |
| FTL020 | 5B | 12-13 | 8-9 | 11.6 |
| FTL021 | 5B | 12-13 | 10 | 10.1 |
| FTL023 | 5B | 7 | 8 | 9.5 |

Examples of Reference Compositions

Table 8 and Table 9 summarize several reference compositions, which are compositions not in accordance with embodiments of the present invention. These are mainly urethane(meth)acrylates.

The compound PPDUA1000 is formed by reacting 2 parts of Velvetol® H1000 with 3 parts of isophorone diisocyanate and 2 part of hydroxyethyl acrylate, thereby forming an urethane(meth)acrylate.

The compound EB8232 is the compound with the commercial name EBECRYL® 8232, which is a difunctional aromatic urethane acrylate oligomer already prediluted in 30-40 wt % DPGDA. The difunctional aromatic urethane acrylate oligomer alone has a viscosity of 340000 mPa s at 23° C.

The compound PPDA250 is further described above, e.g., in Table 1, and is a compound B in accordance with embodiments of the first aspect of the present invention.

In Table 8, for each composition, the amount of each compound in mol % contained in the composition is indicated.

TABLE 8
Reference compositions. The viscosity η at 23° C. is indicated
for each of the compounds and each of the compositions.

| | | REF | FTL | FTL | FTL | FTL | FTL |
|---|---|---|---|---|---|---|---|
| Compound | η_{23° C.} (mPa s) | 8232 | 004 | 016 | 017 | 018 | 022 |
| PPDUA1000 | 1050000 | | 50 | 35 | 35 | 35 | 40 |
| PPDA250 | 21 | | | 65 | | 35 | |
| DPGDA | 10 | 50 | 50 | | 65 | 30 | 60 |
| EB8232 | 7000 | 50 | | | | | |
| Sum of the above | | 100 | 100 | 100 | 100 | 100 | 100 |
| Photoinitiator (BCPK) | | 4 | 4 | 4 | 4 | 4 | 4 |
| η_{23° C.} (mPa s) | | 174 | 3800 | 1200 | 840 | 1030 | 1540 |

Glass Transition and Tensile Properties, Reactivity and Solvent Resistance of Coatings Formed with the Radical Curable Coating Compositions

Table 9 summarizes the glass transition temperature and tensile properties, Table 10 the reactivity and solvent resistance of coatings prepared with the different compositions summarized in Table 8.

TABLE 9
Glass transition temperature and tensile properties for coatings
prepared from the different reference compositions.

| Composition | T_{g} (° C.) | E_{Y} (MPa) | UTE (%) |
|---|---|---|---|
| REF8232 | 54 | 388 ± 16 | 25 + 6 |
| FTL004 | 66 | 204 ± 10 | 56 ± 10 |
| FTL016 | 15 | 47 ± 2 | 14 ± 3 |
| FTL017 | 75 | 454 ± 16 | 24 ± 3 |
| FTL018 | 56 | 169 ± 6 | 23 ± 6 |
| FTL022 | 70 | 327 ± 14 | 27 ± 13 |

TABLE 10
Reactivity and solvent resistance of coatings prepared from reference
compositions, applied and cured on glass and paper as substrate.

| | Reactivity (40 W cm⁻¹ Hg) | Acetone |
|---|---|---|
| Composition | Belt speed (m min⁻¹) | double rubs |
| REF8232 | 20 | >100 |
| FTL004 | 20 | >100 |
| FTL016 | 20 | >100 |
| FTL017 | 20 | >100 |
| FTL018 | 20 | >100 |
| FTL022 | 20 | >100 |

Adhesion, scratch and abrasion properties of wood coatings prepared with the radical curable coating compositions.

TABLE 11
Coating adhesion, scratch and abrasion properties
of coatings prepared from reference compositions,
applied and cured on wood as substrate.

| | | Coin scratch | Pencil scratch | Taber-Grit feed |
|---|---|---|---|---|
| Compo- | Coating | resistance | resistance | Abrasion rate |
| sition | adhesion | (N) | (N) | (mg/100 cycles) |
| REF8232 | 5B | 8 | 4-5 | 13.3 |
| FTL004 | 5B | 29-30 | 15 | 11.8 |
| FTL016 | 5B | 13 | 9 | 9.4 |
| FTL017 | 5B | 17 | 12-13 | 11.4 |
| FTL018 | 5B | 17 | 13 | 8.7 |
| FTL022 | 5B | 14 | 12 | 9.3 |

### Viscosities

By comparing the viscosities measured for the compositions in accordance with embodiments of the present invention summarized in Table 4, with those measured for the reference compositions, containing urethane(meth)acrylates, summarized in Table 8, it appears that the viscosities for the compositions in accordance with embodiments of the present invention are lower. This may be a result of the poly(trimethylene ether) (meth)acrylates, i.e., compounds A, of the present invention themselves have a low viscosity. For example, the compound PPDA2700 has a viscosity of 2940 mPa s, whereas the urethaneacrylate PPDUA1000 has a viscosity of 1050000 mPa s.

While fairly low also, the viscosity of the REF8232 composition was achieved using a higher amount of reactive diluent than the compositions in accordance with embodiments of the present invention.

### Glass Transition and Tensile Properties

From a comparison of the tensile properties for coatings formed with compositions in accordance with embodiments of the present invention summarized in Table 5, with the tensile properties for coatings formed with reference compositions summarized in Table 9, it may be observed that the tensile properties are, generally, in the same range.

Likewise, a similar conclusion can be formulated for the glass transition temperature which should be higher than 30° C. in order to achieve a right balance in stain, solvent, scratch and abrasion resistance when applied as wood coating.

### Reactivity and Solvent Resistance

Tables 6 and 10 show that all the tested compositions have good reactivity and solvent resistance.

### Coating Adhesion, Scratch and Abrasion Resistance

The scratch and abrasion properties for coatings formed with compositions in accordance with embodiments of the present invention, by application of the composition on wood followed by curing of the composition, summarized in Table 7 are systematically better (higher force before scratching and lower abrasion rate) or at least equal to REF8232 reported in Table 11, which is the benchmark based on a urethane acrylate. The other reference compositions, not in accordance with embodiments of the present invention, involve a urethaneacrylate of poly(trimethylene ether) glycol with a very high viscosity. The scratch and abrasion properties of these compositions also exceed the properties of REF8232 but are comparable to the results of the compositions in accordance with embodiments of the present invention.

Hence, compared to the reference compositions, the compositions of the present invention have a lower viscosity while simultaneously enabling the formation of coatings having comparable glass transition and tensile properties, reactivity, solvent and stain resistance as well as excellent scratch and abrasion resistance.

1. A radical curable coating composition comprising
10 wt % to 70 wt % of one or more compounds A, based on the total weight of the coating composition,
30 wt % to 90% wt % of one or more (meth)acrylate compounds B, which are different from the one or more compounds A, based on the total weight of the coating composition, and
0 wt % to 25 wt % of one or more compounds C, different from compounds A and B, based on the total weight of the coating composition,
wherein:
each compound A comprises a poly(trimethylene ether) moiety and one or two (meth)acrylate groups,
wherein the poly(trimethylene ether) moiety is incorporated into compound A by a condensation reaction of a poly(trimethylene ether) glycol with a (meth)acrylate compound selected from the group consisting of (meth)acrylic acid, (meth)acryloyl chloride, and alkylesters thereof,
the poly(trimethylene ether) glycol having a number average molecular weight (Mn), measured by GPC with polystyrene as the standard, of from 900 to 5000 Dalton,
each compound B comprises two or more (meth)acrylate groups,
the one or more (meth)acrylate compounds B, combined, have a viscosity of at most 10000 mPa·s at 25° C. and have a weight average molecular weight of at most 4000 Dalton.

2. The radical curable coating composition according to claim 1, wherein the viscosity of the coating composition is less than 7000 mPa·s at 25° C.

3. The radical curable coating composition according to claim 1, wherein a glass transition point (Tg) of the cured radical curable composition is more than 20° C., and
wherein the Tg is determined using dynamical mechanical thermal analysis (DMTA) on freestanding films of the cured radical curable composition, as described by the standard method ASTM D4065-01.

4. The radical curable coating composition according to claim 1, wherein the poly(trimethylene ether) glycol has a polydispersity Ð of at least 1.5, measured by GPC with polystyrene as a standard.

5. The radical curable coating composition according to claim 1, wherein a biocarbon content of a sum of all compounds A is more than 5% by weight of the total carbon content of the sum of all compounds A, wherein the biocarbon content is measured using the accelerated mass spectrometry protocol described in the standard ASTM D 6866-22.

6. The radical curable coating composition according to claim 5, wherein the biocarbon content of the sum of all compounds A is more than 30% by weight of the total carbon content of the sum of all compounds A, wherein the biocarbon content is measured using the accelerated mass spectrometry protocol described in the standard ASTM D 6866-22.

7. The radical curable coating composition according to claim 6, wherein the biocarbon content of the sum of all compounds A is more than 50% by weight, of the total carbon content of the sum of all compounds A, wherein the biocarbon content is measured using the accelerated mass spectrometry protocol described in the standard ASTM D 6866-22.

8. The radical curable composition according to claim 1, wherein the composition comprises at most 10 wt % urethane (meth)acrylates.

9. (canceled)

10. (canceled)

11. (canceled)

12. A method of forming a coating, comprising applying a layer of the radical curable coating composition according to claim 1, to at least a portion of a substrate, and submitting the coated substrate to curing conditions.

13. The method according to claim 12, wherein the substrate is a wood substrate.

14. The method of forming a coating according to claim 12, wherein the step of applying a layer of a radical curable composition is preceded by a step of applying a primer coat.

15. The method according to claim 12, wherein the step of applying a layer of a radical curable composition is followed by a step of applying a top coat layer.

16. A substrate in contact with the radical curable coating composition according to claim 1.
